(19) United States
(12) Patent Application Publication
(10) Pub. No.: US 2010/0167104 A1
(43) Pub. Date: Jul. 1, 2010

(54) FUEL CELL AND INTEGRATED ANODE FLOW BOARD THEREOF

(75) Inventors: Ming-Chou Tsai, Taoyuan County (TW); Chi-Yang Chiu, Taoyuan County (TW); Chiang-Wen Lai, Taoyuan County (TW); Ching-Sen Yang, Taoyuan Couty (TW); Wei-Kai Chang, Taoyuan County (TW)

Correspondence Address: QUINTERO LAW OFFICE, PC, 615 Hampton Dr, Suite A202, Venice, CA, 90291, US

(73) Assignee: NAN YA PCB CORP., Taoyuan County (TW)

(21) Appl. No.: 12/358,105

(22) Filed: Jan. 22, 2009

(30) Foreign Application Priority Data
Dec. 26, 2008 (TW) TW97150821

(51) Int. Cl. H01M 2/02

(52) U.S. Cl. 429/34

(57) ABSTRACT

A fuel cell includes a cathode board, a membrane electrode assembly, and an integrated anode flow board. The membrane electrode assembly contacts the cathode board. The integrated anode flow board includes an anode flow board and a current collector combined together. The current collector includes a raised portion abutting the membrane electrode assembly.

### BACKGROUND OF THE INVENTION

1. Field of the Invention

The invention relates to a fuel cell and the integrated anode flow board thereof, with improved performance.

2. Description of the Related Art

FIGS. 1A, 1B, 1C, and 1D depict a process for assembling a conventional fuel cell module. Referring to FIG. 1A, first, an anode flow board 100A, adhesive materials 100C, current collectors 100B, and fixing frames 100D are combined as an integrated anode flow board 100 as shown in FIG. 1B. Referring to FIG. 1C, next, the integrated anode flow board 100 is combined with cathode boards 120, adhesive sheets 140, and membrane electrode assemblies (MEAs) 160 as a fuel cell module 10 shown in FIG. 1D. Note that the adhesive sheets 140 have central openings, allowing a contact of the MEAs 160 with the current collector 100B of the integrated anode flow board 100 as well as the central collecting zones 1201 of the cathodes 120.

After a period of use, however, the performance of the conventional fuel cell is significantly reduced. Therefore, a solution for maintaining the performance of fuel cells is desirable.

### BRIEF SUMMARY OF THE INVENTION

The invention modifies the structure of a conventional fuel cell to solve the described problem.

The fuel cell in accordance with an exemplary embodiment of the invention includes a cathode board, a membrane electrode assembly, and an integrated anode flow board. The membrane electrode assembly contacts the cathode board. The integrated anode flow board includes an anode flow board and a current collector combined together. The current collector includes a raised portion abutting the membrane electrode assembly.

In another exemplary embodiment, the anode flow board includes a plurality of bars supporting the raised portion of the current collector.

In yet another exemplary embodiment, the bars have a plurality of bumps abutting the raised portion, and the bumps are thicker at a center of the anode flow board and thinner on both sides of the anode flow board to match a configuration of the raised portion of the current collector.

In another exemplary embodiment, the bars are parallel to each other and form a plurality of channels therebetween, allowing fuel to flow into the membrane electrode assembly.

The invention also provides an integrated anode flow board, including an anode flow board and a current collector. The current collector, including a raised portion, is combined with the anode flow board.

In another exemplary embodiment, the integrated anode flow board includes a plurality of bars supporting the raised portion of the current collector.

In yet another exemplary embodiment, the bars have a plurality of bumps abutting the raised portion, and the bumps are thicker at a center of the anode flow board and thinner on both sides of the anode flow board to match a configuration of the raised portion of the current collector.

In another exemplary embodiment, the bars are parallel to each other and form a plurality of channels therebetween, allowing fuel to flow into the membrane electrode assembly.

The invention also provides a fuel cell including a fuel cell module and a first cathode flow board. The fuel cell module includes a cathode board, a membrane electrode assembly, and an integrated anode flow board combined together. The first cathode flow board includes a rib abutting the cathode board.

In another exemplary embodiment, the fuel cell further includes an end plate which is curved, abuts the cathode flow board, and pushes the rib of the first cathode flow board toward the cathode board.

In yet another exemplary embodiment, the end plate of the fuel cell is made of spring steel.

In another exemplary embodiment, the fuel cell further includes a threaded rod and a nut which connects the fuel cell module, the first cathode flow board, and the end plate together.

The invention also provides a fuel cell, including a plurality of fuel cell modules and a second cathode flow board. Each of the fuel cell modules include a cathode board, a membrane electrode assembly, and an integrated anode flow board combined together. The second cathode flow board is interposed between the fuel cell modules, including a frame body and a plurality of ribs disposed on both sides of the frame body to abut the cathode board.

In another exemplary embodiment, the fuel cell further includes a pair of first cathode flow boards, each of which include a rib abutting the cathode board. The fuel cell modules are held by the first cathode flow boards.

In yet another exemplary embodiment, the fuel cell further includes two end plates, wherein the first cathode flow boards are held by the end plates. At least one end plate is curved, abuts the first cathode flow board corresponding thereto, and pushes the rib of the first cathode flow board toward the cathode board.

In another exemplary embodiment, the end plates of the fuel cell are made of spring steel.

In yet another exemplary embodiment, the fuel cell further includes a threaded rod and a nut which connects the fuel cell modules, the first cathode flow boards, the second cathode flow board, and the end plates together.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A, 1B, 1C, and 1D depict a process for assembling a conventional fuel cell module;

FIG. 2 depicts a fuel cell module in accordance with a first embodiment of the invention;

FIG. 3 is an exploded diagram of the fuel cell module of FIG. 2;

FIG. 4A is a schematic diagram of the anode flow board of FIG. 3;

FIG. 4B is an enlarged local view of the anode flow board of FIG. 4A;

FIG. 5 is a perspective diagram of the current collector of the integrated anode flow board of FIG. 3;

FIG. 6A is a VI-VI sectional view of the fuel cell module of FIG. 2;

FIG. 6B is an enlarged local view of the fuel cell module of FIG. 6A;

FIG. 7 depicts a fuel cell assembly in accordance with a second embodiment of the invention;

FIG. 8 depicts a fuel cell stack in accordance with a third embodiment of the invention; and

FIG. 9 is a schematic diagram of the second cathode flow board of FIG. 8.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

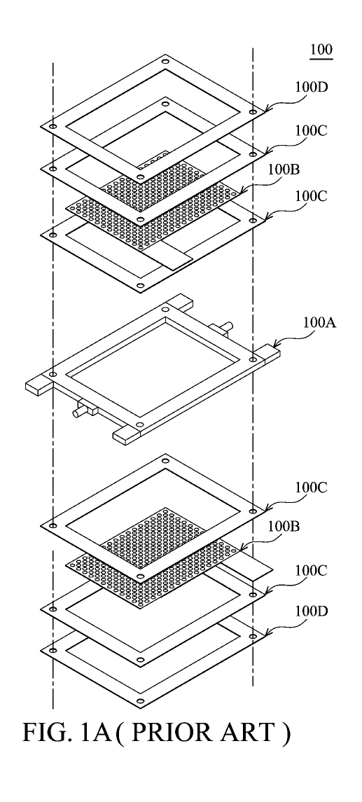

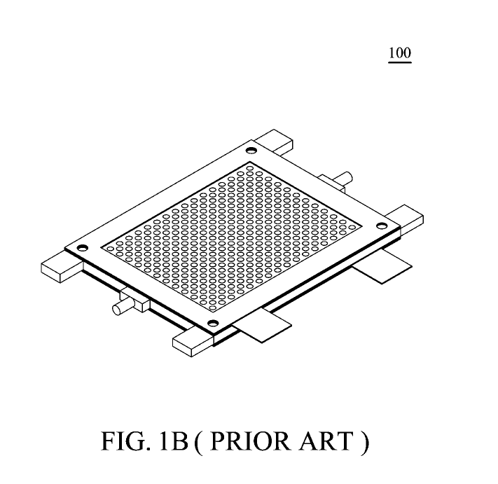

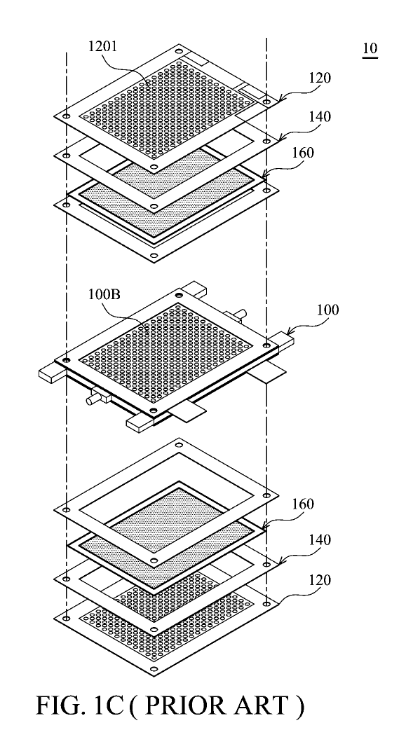

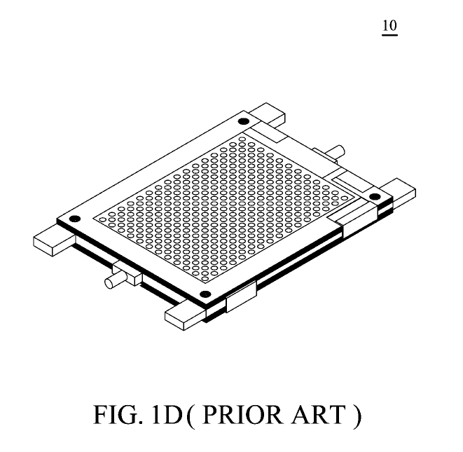

In efforts to meet compact and lightweight requirements, elements of fuel cells are made of polymer composite materials. After a period of use, however, it is found that the cathode board (FIG. 1C) made of polymer composite materials, will be raised. As a result, the contact resistance of the fuel cell will increase and the performance of the fuel cell will be reduced. Accordingly, the invention modifies the structure of a fuel cell to solve this problem.

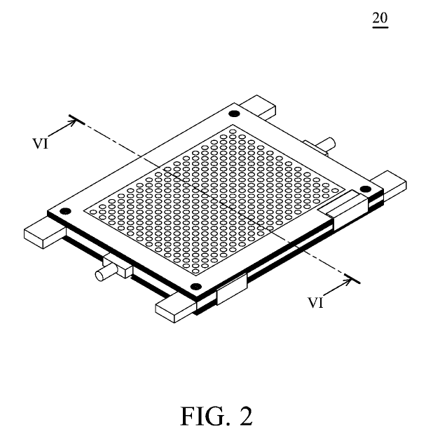

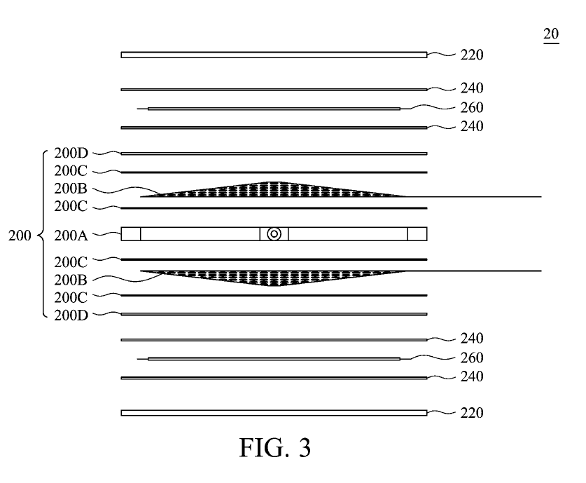

FIG. 2 depicts a fuel cell module in accordance with a first embodiment of the invention and FIG. 3 is an exploded diagram of the fuel cell module of FIG. 2. Note that FIG. 3 is a side view of the fuel cell module rather than a sectional view. As shown, a fuel cell module 20 includes an integrated anode flow board 200, two cathode boards 220, a plurality of adhesive sheets 240, and two membrane electrode assemblies (MEAs) 260 combined together. The integrated anode flow board 200 includes an anode flow board 200A, a plurality of adhesive materials 200C, two current collectors 200B, and two fixing frames 200D.

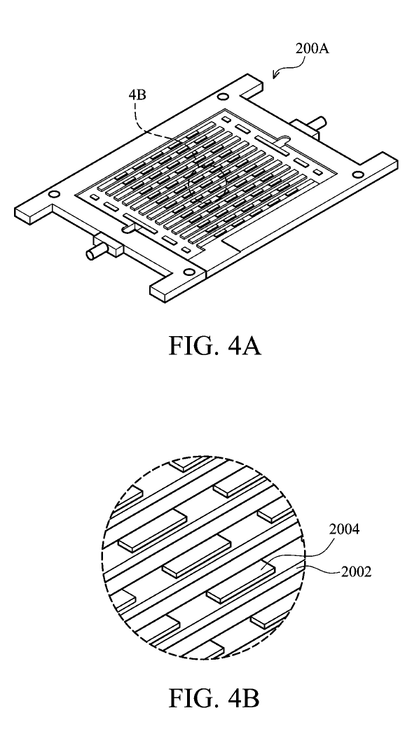

Referring to FIGS. 4A and 4B, a plurality of parallel bars 2002 is provided on the anode flow board 200A to form channels therebetween, allowing fuel to flow into the MEAs 260. Furthermore, the bars 2002 have bumps 2004 of different thicknesses provided thereon.

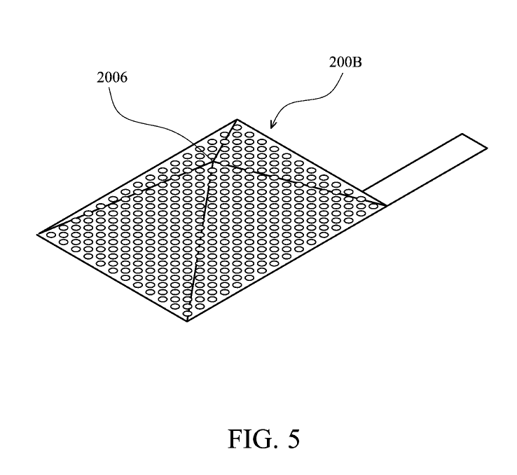

FIG. 5 is a perspective diagram of the current collector 200B of the integrated anode flow board 200, wherein the current collector 200B is not planar but has a raised portion 2006.

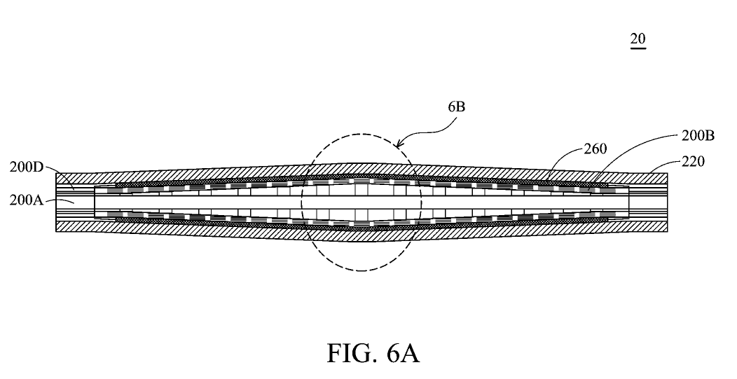

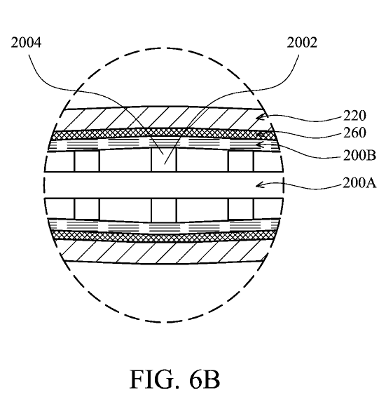

Referring to FIG. 6A and FIG. 6B, the current collector 200B has the raised portion 2006 abutting the MEA 260. The MEA 260 and the cathode board 220, which were originally planar, are thus raised by the current collector 200B. That is, there is pre-deformation of the cathode board 220 in the fuel cell module. Under such a circumstance, the cathode board 220 will not further deform, even after further use. Additionally, the current collector 200B has the raised portion 2006 tightly contacting the MEA 260, thus, effectively preventing increase of the contact resistance of the fuel cell and reduction in the performance of the fuel cell.

Each bars 2002 have a plurality of bumps 2004 provided thereon to support the current collector 200B. This ensures tight contact of the current collector 200B with the MEA 260. As described, the bumps 2004 are of different thicknesses. To match the configuration of the raised portion 2006 of the current collector 200B, the bumps 2004 are thicker at the center of the anode flow board 200A and thinner on both sides.

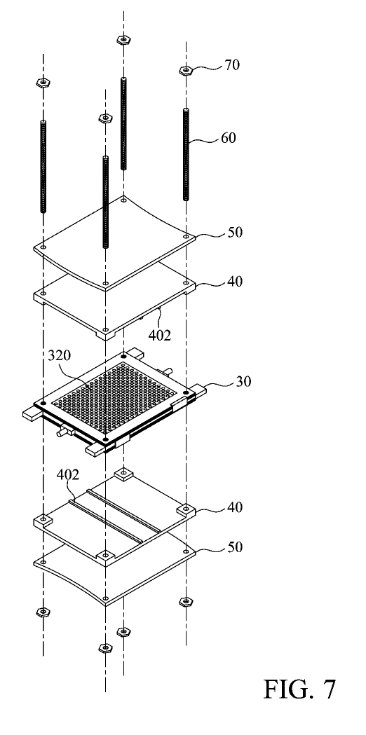

FIG. 7 depicts a fuel cell assembly in accordance with a second embodiment of the invention, wherein the fuel cell assembly includes a fuel cell module 30, two first cathode flow boards 40, and two end plates 50, described in the following.

The fuel cell module 30 is held by the first cathode flow boards 40 and the end plates 50, and tightened by threaded rods 60 and nuts 70. The nuts 70 are capable of adjusting the pressure of the end plates 50 on the first cathode flow boards 40 and the fuel cell module 30.

The first cathode flow board 40 has a plurality of parallel ribs 402 thereon. For assembly, the ribs 402 abut the cathode board 320 of the fuel cell module 30.

The end plate 50 is not planar but curved, inwardly abutting the first cathode flow board 40. The end plate 50 is made of, for example, spring steel or other materials of good elasticity.

Due to the rib 402 of the end plate 50 abutting the cathode board 320 of the fuel cell module 30, this embodiment of the invention is capable of effectively preventing deformation of the cathode board 320, increase of the contact resistance of the fuel cell and reduction in the performance of the fuel cell. Additionally, the power density of the fuel cell is increased.

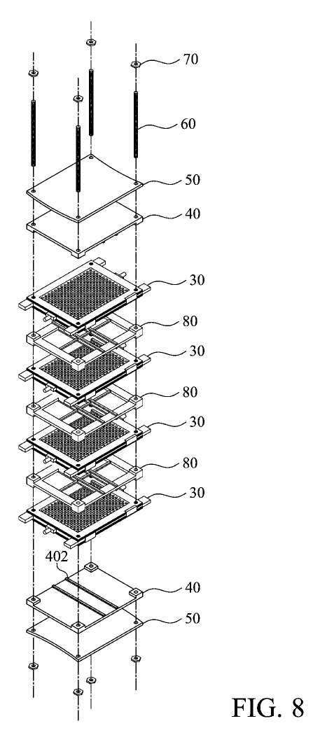

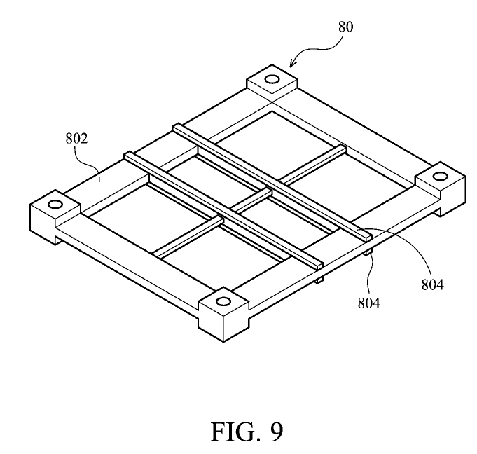

A higher output voltage can be obtained by connecting a plurality of fuel cell modules in series. FIG. 8 depicts a fuel cell stack in accordance with a third embodiment of the invention, wherein the fuel cell stack includes a plurality of fuel cell modules 30, two first cathode flow boards 40, a plurality of second cathode flow boards 80, and two end plates 50, described in the following.

The outmost elements of the fuel cell stack are the end plates 50 which are curved and inwardly abut the first cathode flow boards 40. The end plates 50 are made of, for example, spring steel or other materials of good elasticity.

The first cathode flow board 40 has a plurality of parallel ribs 402 thereon. For assembly, the ribs 402 abut the cathode board 320 of the fuel cell module 30.

The fuel cell modules 30 are interposed between a first cathode flow board 40 and a second cathode flow board 80, or between two second cathode flow boards 80, and tightened by threaded rods 60 and nuts 70. The nuts 70 are capable of adjusting pressure of the first cathode flow boards 40 and the second cathode flow boards 80 on the fuel cell modules 30.

Referring to FIG. 9, the second cathode flow board 80 has a frame body 802, and a plurality of ribs 804 formed on both sides of the frame body 802 for abutting the fuel cell modules 30.

Due to the ribs 402 and 804 abutting the cathode boards of the fuel cell modules 30, this embodiment of the invention is capable of effectively preventing deformation of the cathode boards, increase of the contact resistance of the fuel cell, and reduction in performance of the fuel cell.

The first, second, and third embodiments are provided for introducing the invention, wherein the first embodiment is applicable to lower-powered fuel cells, and the second and third embodiments are applicable to higher-powered fuel cells.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell, comprising:
a cathode board;
a membrane electrode assembly contacting the cathode board; and
an integrated anode flow board including an anode flow board and a current collector combined together, wherein the current collector includes a raised portion abutting the membrane electrode assembly.

2. The fuel cell as claimed in claim 1, wherein the anode flow board includes a plurality of bars supporting the raised portion of the current collector.

3. The fuel cell as claimed in claim 2, wherein the bars have a plurality of bumps abutting the raised portion, and the bumps are thicker at a center of the anode flow board and thinner on both sides of the anode flow board to match a configuration of the raised portion of the current collector.

4. The fuel cell as claimed in claim 2, wherein the bars are parallel to each other and form a plurality of channels therebetween, allowing fuel to flow into the membrane electrode assembly.

5. An integrated anode flow board, comprising:
an anode flow board; and
a current collector combined with the anode flow board, including a raised portion.

6. The integrated anode flow board as claimed in claim 5, wherein the anode flow board includes a plurality of bars supporting the raised portion of the current collector.

7. The integrated anode flow board claimed in claim 6, wherein the bars have a plurality of bumps abutting the raised portion, and the bumps are thicker at a center of the anode flow board and thinner on both sides of the anode flow board to match a configuration of the raised portion of the current collector.

8. The integrated anode flow board as claimed in claim 6, wherein the bars are parallel to each other and form a plurality of channels therebetween, allowing fuel to flow into the membrane electrode assembly.

9. A fuel cell, comprising:
a fuel cell module including a cathode board, a membrane electrode assembly, and an integrated anode flow board combined together; and
a first cathode flow board including a rib abutting the cathode board.

10. The fuel cell as claimed in claim 9, further comprising an end plate which is curved, abuts the cathode flow board, and pushes the rib of the first cathode flow board toward the cathode board.

11. The fuel cell as claimed in claim 10, wherein the end plate is made of spring steel.

12. The fuel cell as claimed in claim 10, further comprising a threaded rod and a nut which connects the fuel cell module, the first cathode flow board, and the end plate together.

13. A fuel cell, comprising:
a plurality of fuel cell modules, each of which include a cathode board, a membrane electrode assembly, and an integrated anode flow board combined together; and
a second cathode flow board interposed between the fuel cell modules, including a frame body and a plurality of ribs disposed on both sides of the frame body to abut the cathode board.

14. The fuel cell as claimed in claim 13, further comprising a pair of first cathode flow boards, each of which include a rib abutting the cathode board, wherein the fuel cell modules are held by the first cathode flow boards.

15. The fuel cell as claimed in claim 14, further comprising two end plates, wherein the first cathode flow boards are held by the end plates, and at least one end plate is curved, abuts the first cathode flow board corresponding thereto, and pushes the rib of the first cathode flow board toward the cathode board.

16. The fuel cell as claimed in claim 15, wherein the end plates are made of spring steel.

17. The fuel cell as claimed in claim 15, further comprising a threaded rod and a nut which connects the fuel cell modules, the first cathode flow boards, the second cathode flow board, and the end plates together.
